(19) United States
(12) Patent Application Publication
(10) Pub. No.: US 2019/0360264 A1
(43) Pub. Date: Nov. 28, 2019

(54) CURTAIN FRAME

(71) Applicant: NingBo Liyang Curtain Company Limited, NINGBO (CN)

(72) Inventor: BAOGUO TAN, NINGBO (CN)

(73) Assignee: NingBo Liyang Curtain Company Limited

(21) Appl. No.: 15/989,182

(22) Filed: May 25, 2018

(51) Int. Cl. E06B 9/32

(52) U.S. Cl. CPC E06B 9/32; E06B 9/262

(57) ABSTRACT

The present disclosure discloses a curtain frame comprising a box body, a curtain cloth, a lower rod, a spring bracket, a wire tray bracket and an end wire tray bracket. The box body includes a first side surface, a second side surface and a connecting surface. At least two curtain rope apertures are provided on the connecting surface. The wire tray bracket, the spring bracket and the end wire tray bracket are arranged in the box body. One end of the curtain cloth is arranged within the box body and the other end of the curtain cloth is arranged within a lower rod. The curtain ropes can be hidden within the box body and the curtain cloth by using embodiments of the present disclosure. Movement of the curtain cloth can be performed by moving the wire tray bracket inside the box body with an elastic force provided by springs.

### TECHNICAL FIELD

The present disclosure relates to the field of home furnishing, and more particularly, to a curtain frame.

### BACKGROUND OF THE PRESENT INVENTION

Shutters are widely used in homes and offices to separate spaces or block sunlight. Shutters are generally divided into two types: The first type of shutter has its blind always in place. Opening and closing are achieved by changing the angle of the blind. Although the first type of curtain provides better shielding effects, a lack of illumination in the room would be caused. Additional lighting might be necessary even in daytime, which causes indoor light pollution and a waste of energy. The second type of shutter can have its blind pulled up or down to separate spaces or block sunlight. When no shielding is required or indoor illumination is insufficient, the blind can be pulled up to raise illumination intensity within the room. Drawstrings on the blind have to be pulled when using the second type of shutter. The drawstrings include a drawstring to adjust the flip angle of the blind, and another drawstring to pull up or down the blind. Such drawstrings may become inconvenient in use and even fail sometimes.

### SUMMARY OF PRESENT INVENTION

An objective of the present disclosure is to alleviate some of the problems of prior arts and allow opening and closing of the curtain without using the drawstring.

The present disclosure discloses a curtain frame comprising a box body, a curtain cloth, a lower rod, a spring bracket, a wire tray bracket and an end wire tray bracket. The box body includes a first side surface, a second side surface, and a connecting surface connecting the first side surface and the second side surface. The connecting surface has at least two curtain rope apertures. The first side surface has a first long side and a second long side. The first long side has a first bent part bent in the direction of the connecting surface. The second long side has a second bent part bent in the direction of the connecting surface. The second side surface has a third long side and a fourth long side. The third long side has a third bent part bent in the direction of the connecting surface. The fourth long side has a fourth bent part bent in the direction of the connecting surface.

The first bent part, the first side surface, the connecting surface, the second side surface, and the third bent part form a first track of a curtain cloth. An upper end of the curtain cloth is disposed in the first track. The second bent part, the first side surface, the connecting surface, the second side surface, and the fourth bent part form a curtain box space. The spring bracket and the end wire tray bracket are fixedly disposed in the curtain box space. The wire tray bracket is movably disposed in the curtain box space. A spring bracket holder is arranged on the connecting surface in the curtain box space to hold the spring bracket. The first side surface has a first protrusion part arranged parallel to the connection surface along an axial direction of its inner wall defining the curtain box space. The second side surface has a second protrusion part arranged parallel to the connection surface along an axial direction of its inner wall defining the curtain box space. A distance between the first protrusion part and the connection surface is equal to a distance between the second protrusion part and the connection surface. The lower end of the curtain cloth is disposed in the lower rod, the lower rod has a pull ring, a pull hook movably connected to the pull ring, and a pull rod fixed to the pull hook. The end wire tray bracket includes an end wire tray base, at least two pulleys, at least two pulley shafts, and an end wire tray cover, the number of pulleys equals to the number of pulley shafts. The end wire tray base is fixed on the connecting surface in the curtain box space. The pulley shafts are disposed on the end wire tray base. The end wire tray cover is fixed with the end wire tray base.

In some embodiments, the spring bracket comprises a coil, a bracket base, a first spring, a second spring, a first spring sleeve, a second spring sleeve, a first shaft, a second shaft, and a third shaft. The first spring is wound around the first spring sleeve. The second spring is wound around the second spring sleeve. The first spring sleeve passes through the first shaft, the second spring sleeve passes through the third shaft, the coil passes through the second shaft, and the coil has a reel and a spool which are axially arranged. The first spring and the second spring are fixed to the reel. A connecting rope is arranged on the spool and connected to the wire tray bracket on one end.

In some embodiments, the bracket cover comprises a first shaft fixing hole, a second shaft fixing hole and a third shaft fixing hole, and the bracket cover is screwed to the second shaft.

In some embodiments, the wire tray bracket comprises a wire tray base, at least two wire pulleys, a first fixed pulley, a second fixed pulley, a third fixed pulley, a fourth fixed pulley and a wire tray cover fixed to the wire tray base. The first fixed pulley and the second fixed pulley are movably clamped on the first protrusion part. The third fixed pulley and the fourth fixed pulley are movably clamped on the second protrusion part. The wire tray base includes two wire pulley shafts and four fixed pulley shafts. The wire tray cover includes connecting rope apertures.

In some embodiments, the lower rod is formed as a hollow pipe. The cross-section of the lower rod is elliptical. A separator parallel to a long axis of the elliptical cross-section is arranged in the lower rod; an axial through-hole is provided on a plane of the lower rod. A lower end of the curtain cloth is disposed between the separator and the axial through-hole.

In some embodiments, the curtain frame further comprises a mounting bracket having an L-shaped mounting bracket body, a snap hook and a fixing stopper. The L-shaped mounting bracket body includes a first mounting body having a first mounting hole, and a second mounting body having a second mounting hole. A first L-folded part and a second L-folded part are arranged respectively on two sides of the second mounting body. The snap hook is clamped between the first L-folded part and the second L-folded part, and the fixing stopper is arranged in a recess arranged on a surface of the snap hook opposite to the second mounting body.

Several advantages can be provided by using the embodiments of the disclosure herein. The curtain ropes are hidden in the box body and the curtain cloth through the designs of the box body, the spring bracket, the wire tray bracket and the end wire tray bracket. Opening and closing of the curtain cloth within the box body can be achieved by moving the wire tray bracket inside the box body with an elastic force provided by the springs, and the need to pull a drawstring is eliminated.

### DESCRIPTION OF THE DRAWINGS

FIG. 1 is a break-down view of a curtain frame according to the present disclosure.

FIG. 2 is a structural schematic of a box body according to the present disclosure.

FIG. 3 is a structural schematic of a spring bracket according to the present disclosure.

FIG. 4 is a break-down view of FIG. 3.

FIG. 5 is a structural schematic of a wire tray bracket according to the present disclosure.

FIG. 6 is a break-down view of FIG. 5.

FIG. 7 is a structural schematic of an end wire tray bracket according to the present disclosure.

FIG. 8 is a break-down view of FIG. 7.

FIG. 9 is a break-down view of the mounting bodies according to the present disclosure.

FIG. 10 is a structural schematic of a lower rod according to the present disclosure.

FIG. 11 is a break-down view of the lower rod according to the present disclosure.

### REFERENCE NUMBERS

1 box body, 2 spring bracket, 3 wire tray bracket, 4 end wire tray bracket, 5 left cover, 6 right cover, 7 mounting bracket, 8 spring bracket holder, 101 first side surface, 102 second side surface, 103 first long side, 104 second long side, 105 first bent part, 106 second bent part, 107 connecting surface, 108 first protrusion part, 109 third bent part, 110 third long side, 111 second protrusion part, 112 fourth long side, 113 fourth bent part, 114 curtain box space, 201 bracket base, 202 bracket cover, 203 first spring sleeve, 204 first spring, 205 spool, 206 reel 207, second spring sleeve, 208 second spring, 209 coil, 210 first shaft, 211 second shaft, 212 third shaft, 213 first shaft fixing hole, 214 second shaft fixing hole, 215 third shaft fixing hole, 301 wire tray base, 302 wire pulley, 303 fixed pulley, 304 wire tray cover, 305 first fixed pulley, 306 second fixed pulley, 307 third fixed pulley. 308 fourth fixed pulley, 309 fixed pulley axis, 310 wire pulley shaft, 311 connecting rope aperture. 401 end wire tray base, 402 pulley, 403 end wire tray cover, 404 pulley shaft, 701 mounting bracket body, 702 snap hook, 703 fixing stopper, 704 recess, 705 first mounting body, 706 second mounting body, 707 first mounting hole. 708 second mounting hole, 709 first L-folded part, 710 second L-folded part, 901 lower rod, 902 through-hole, 903 left plug head, 904 right plug head, 905 pull ring, 906 pull hook, 907 pull rod, 908 separator.

### DETAILED DESCRIPTION OF PREFERRED EMBODIMENTS

The technical solutions of the present disclosure are described herein by way of exemplary embodiments, but not by limitation. The scope of the inventive concept of the present disclosure is not limited to the embodiments.

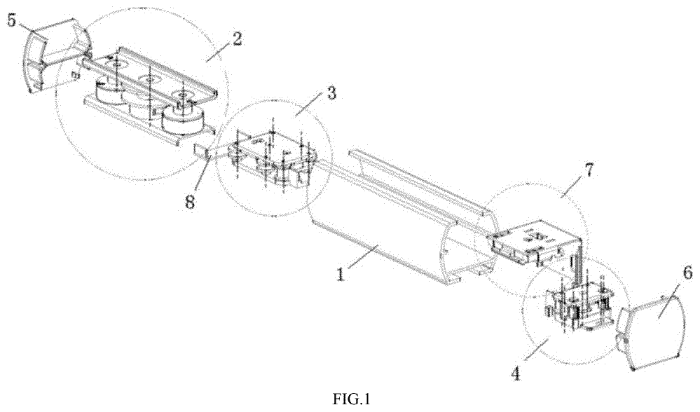

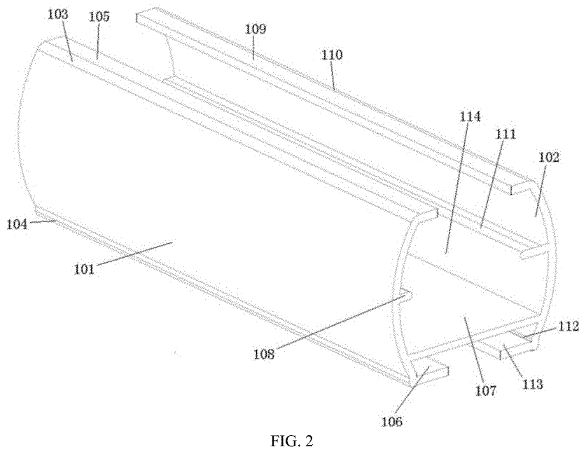

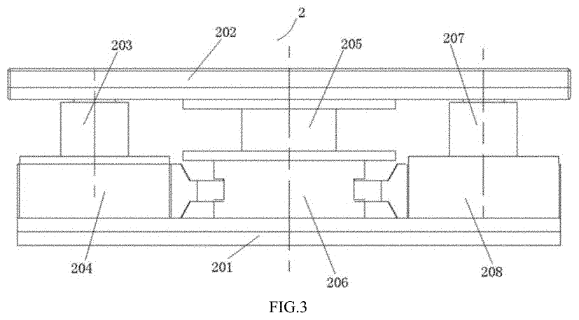

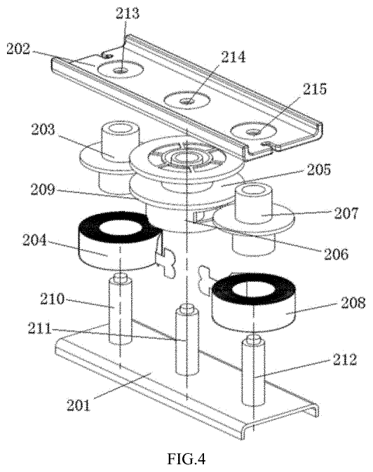

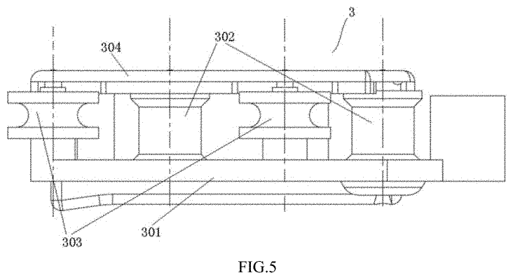

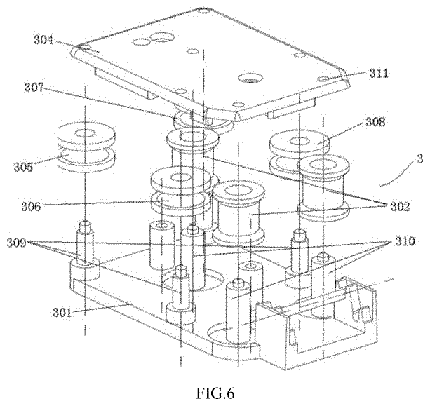

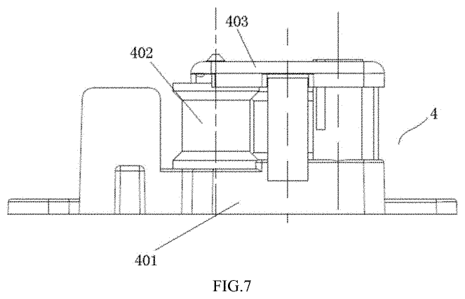

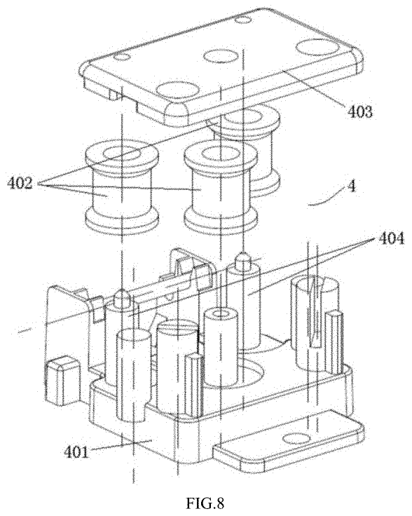

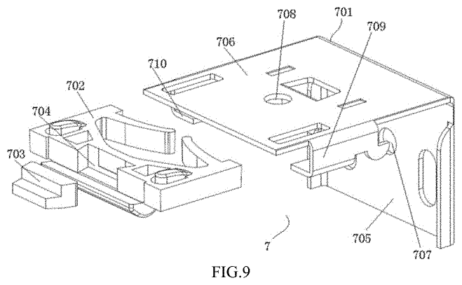

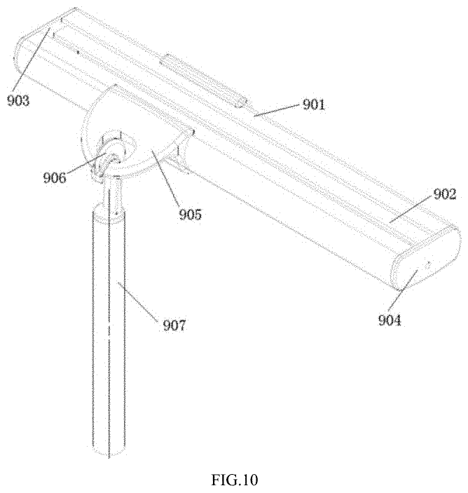

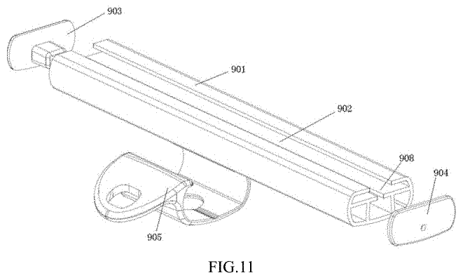

As shown in FIG. 1-11, a curtain frame is provided which comprises a box body 1, a curtain cloth, a lower rod 901, a spring bracket 2, a wire tray bracket 3 and an end wire tray bracket 4. The box body 1 includes a first side surface 101, a second side surface 102, and a connecting surface 107 connecting the first side surface 101 and the second side surface 102. The connecting surface 107 has at least two curtain rope apertures. The first side surface 101 and the second side surface 102 herein share the same size, shape, and structure, and they are interchangeable. The front views of the first side surface 101 and the second side surface 102 herein both show a rectangular shape.

The first side surface 101 has a first long side 103 and a second long side 104. The first long side 103 has a first bent part 105 bent in the direction of the connecting surface 107. The second long side 104 has a second bent part 106 bent in the direction of the connecting surface 107. The second side surface 102 has a third long side 110 and a fourth long side 112. The third long side 110 has a third bent part 109 bent in the direction of the connecting surface 107. The fourth long side 113 has a second bent part 113 bent in the direction of the connecting surface 107.

The first bent part 105, the first side surface 101, the connecting surface 107, the second side surface 102, and the third bent part 109 form a first track of a curtain cloth. An upper end of the curtain cloth is disposed in the first track. A gap is left between the first bend part 105 and the third bend part 109.

The second bent part 106, the first side surface 101, the connecting surface 107, the second side surface 102, and the fourth bent part 113 form a curtain box space 114. The spring bracket 2 and the end wire tray bracket 4 are fixedly disposed in the curtain box space 114. The wire tray bracket 3 is movably disposed in the curtain box space 114. A gap is formed between the second bent part 106 and the fourth bend part 113.

The first side surface 101 has a first protrusion part 108 arranged parallel to the connection surface 107 along an axial direction of its inner wall defining the curtain box space 114. The second side surface 102 has a second protrusion part 111 arranged parallel to the connection surface 107 along an axial direction of its inner wall defining the curtain box space 114. A distance between the first protrusion part 108 and the connection surface 107 is equal to a distance between the second protrusion part 111 and the connection surface 107. Therefore, the first protrusion part 108 and the second protrusion part 111 form a track structure. The wire tray bracket 3 can slide on the track formed by the first protrusion part 108 and the second protrusion part 111.

A left cover 5 and a right cover 6 are arranged on two ends of the box body 1 to close the two ends of the box body 1 and prevent the spring bracket 2 from extending outside the box body 1. The lower end of the curtain cloth is arranged within the lower rod 901.

The curtain cloth includes a plurality of flexible sheet structures. The flexible sheet structures allow the curtain cloth to curve or transform when the curtain is opened or closed. The flexible sheet structures can be manufactured with polymer fiber. The flexible sheet structures are formed by connecting the sheets in series. The two outmost sheets become the upper end and the lower end of the curtain cloth. Each sheet comprises a first surface and a second surface. The two longer edges of the first surface overlap with the two longer edges of the second surface. Therefore, the flexible sheet structures actually form a flattened cylindrical structure. Every first surface is connected to a second face of an adjacent sheet and every second surface is connected to a first face of an adjacent sheet. Consider three adjacent sheets which include a first sheet having surfaces A and B, a second sheet having surfaces C and D, and a third sheet having surfaces E and F. The surface B is connected to the surface C. The surface D is connected to the surface E, and so on.

The spring bracket 2 comprises a coil 209, a bracket base 201, a first spring 204, a second spring 208, a first spring sleeve 203, a second spring sleeve 207, a first shaft 210, a second shaft 211, and a third shaft 212. Both springs 204 and 208 can be tablet springs. The three shafts 210, 211, and 212 are all fixed on the bracket base 201. The first spring 204 is wound around the first spring sleeve 203. One end of the first spring 204 is connected to the first spring sleeve 203. The second spring 208 is wound around the second spring sleeve 207. One end of the second spring 208 is connected to the second spring sleeve 207. The first spring sleeve 203 and the second spring sleeve 207 rotate in opposite directions when opening or closing the curtain. The first spring sleeve 203 passes through the first shaft 210. The second spring sleeve 207 passes through the third shaft 212. The coil 209 passes through the second shaft 211. The coil 209 has a reel 206 and a spool 205 which are axially arranged. The first spring 204 and the second spring 208 are fixed to the reel 206 on one end. A connecting rope is arranged on the spool 205 and connected to the wire tray bracket 3 on one end. The connecting rope is wound around the spool 205. The connecting rope can be wound or unwound with movement of the curtain cloth to induce a driving force on the wire tray bracket 3.

The bracket cover 202 comprises a first shaft fixing hole 213, a second shaft fixing hole 214 and a third shaft fixing hole 215. Thread holes are provided on the ends of the second shaft 211 and the bracket cover 203 can be screwed to the second shaft 211.

A spring bracket holder 8 is arranged on the connecting surface 107 in the curtain box space 114 to hold the spring bracket 2. When using the spring bracket holder 8 to separate the spring bracket 2 from the wire tray bracket 3, it is no longer need to fix the spring bracket 2 to the curtain box space 114.

The wire tray bracket 3 comprises a wire tray base 301, at least two wire pulleys 302, a first fixed pulley 305, a second fixed pulley 306, a third fixed pulley 307, a fourth fixed pulley 208 and a wire tray cover 304 fixed to the wire tray base 301. The four fixed pulleys 303 can be arranged on four corners of the wire tray bracket 3. The first fixed pulley 305 and the second fixed pulley 306 are movably clamped on the first protrusion part 108. The third fixed pulley 307 and the fourth fixed pulley 308 are movably clamped on the second protrusion part 111. The wire tray base 301 includes two wire pulley shafts 310 and four fixed pulley shafts 309.

The wire tray cover 304 is fixed to the wire tray base 301. The wire tray cover 304 may include connecting rope apertures 311. The end wire tray bracket 4 comprises a end wire tray base 401, at least two pulleys 402, an end wire tray cover 403, and at least two pulley shaft 404. The number of pulleys 402 equals to the number of pulley shafts 404. The end wire tray base 401 is fixed on the connecting surface 107 in the curtain box space 114. The pulley shafts 404 are disposed on the end wire tray base 401. The end wire tray cover 403 is fixed with the end wire tray base 401.

The lower rod 901 is formed as a hollow pipe. The cross-section of the lower rod 901 is elliptical. A separator 908 parallel to a long axis of the elliptical cross-section is arranged in the lower rod 901. An axial through-hole 902 is provided on a plane of the lower rod 901. A lower end of the curtain cloth is disposed between the separator 908 and the axial through-hole 902. A left plug head 903 and a right plug head 904 are arranged on the two ends of the lower rod 901. The lower rod 901 has a pull mechanism including a pull ring 905, a pull hook 906 movably connected to the pull ring, and a pull rod 907 fixed to the pull hook 906. The pull ring 905 is fixed to the lower rod 901. The pull hook 906 is fixedly connected with the pull rod 907. The pull hook 906 is movably connected with the pull ring 905.

A mounting bracket 7 having an L-shaped mounting bracket body 701, a snap hook 702 and a fixing stopper 703 can be included. In some embodiments, two mounting brackets 7 can be included. The mounting bracket body 701 can be divided into a first mounting body 705 and a second mounting body 706. The first mounting body 705 has a first mounting hole 707, and the second mounting body 706 having a second mounting hole 708. A first L-folded part 709 and a second L-folded part 710 are arranged respectively on two sides of the second mounting body 706. The snap hook 702 is clamped between the first L-folded part 709 and the second L-folded part 710. The fixing stopper 703 is arranged in a recess 704 arranged on a surface of the snap hook 702 opposite to the second mounting body 706.

After one end of the curtain rope is fixed with the lower rod 901, it passes through the curtain cloth, and is perforated through a curtain rope aperture on the connecting surface 107, and then passes through the pulley of the end wire tray bracket 4 and the wire pulley 402 on the wire tray bracket 3, and then passes through the connecting surface 107. The assembly of the curtain box is completed by perforating the curtain rope and fixing an end of it with the lower rod 901.

Although certain embodiments have been illustrated and described herein for purposes of description, a wide variety of alternate and/or equivalent embodiments or implementations to achieve the same purposes may be substituted for the embodiments shown and described without departing from the scope of the present disclosure. This application is intended to cover any adaptations or variations of the embodiments discussed herein.

I claim:

1. A curtain frame, comprising: a box body, a curtain cloth, a lower rod, a spring bracket, a wire tray bracket and an end wire tray bracket, wherein:
the box body includes a first side surface, a second side surface, and a connecting surface connecting the first side surface and the second side surface, the connecting surface has at least two curtain rope apertures, the first side surface has a first long side and a second long side, the first long side has a first bent part bent in the direction of the connecting surface, the second long side has a second bent part bent in the direction of the connecting surface, the second side surface has a third long side and a fourth long side, the third long side has a third bent part bent in the direction of the connecting surface, the fourth long side has a fourth bent part bent in the direction of the connecting surface;
the first bent part, the first side surface, the connecting surface, the second side surface, and the third bent part form a first track of a curtain cloth, an upper end of the curtain cloth is disposed in the first track;
the second bent part, the first side surface, the connecting surface, the second side surface, and the fourth bent part form a curtain box space, the spring bracket and the end wire tray bracket are fixedly disposed in the curtain box space, the wire tray bracket is movably disposed in the curtain box space, a spring bracket holder is arranged on the connecting surface in the curtain box space to hold the spring bracket;
the first side surface has a first protrusion part arranged parallel to the connection surface along an axial direction of its inner wall defining the curtain box space, the second side surface has a second protrusion part arranged parallel to the connection surface along an axial direction of its inner wall defining the curtain box space, a distance between the first protrusion part and the connection surface is equal to a distance between the second protrusion part and the connection surface;
the lower end of the curtain cloth is disposed in the lower rod, the lower rod has a pull ring, a pull hook movably connected to the pull ring, and a pull rod fixed to the pull hook; and
the end wire tray bracket includes an end wire tray base, at least two pulleys, at least two pulley shafts, and an end wire tray cover, the number of pulleys equals to the number of pulley shafts;
the end wire tray base is fixed on the connecting surface in the curtain box space, the pulley shafts are disposed on the end wire tray base, the end wire tray cover is fixed with the end wire tray base.

2. The curtain frame of claim 1, wherein:
the spring bracket comprises a coil, a bracket base, a first spring, a second spring, a first spring sleeve, a second spring sleeve, a first shaft, a second shaft, and a third shaft;
the first spring is wound around the first spring sleeve, the second spring is wound around the second spring sleeve;
the first spring sleeve passes through the first shaft, the second spring sleeve passes through the third shaft, the coil passes through the second shaft; and
the coil has a reel and a spool which are axially arranged, the first spring and the second spring are fixed to the reel, a connecting rope is arranged on the spool and connected to the wire tray bracket on one end.

3. The curtain frame of claim 2, wherein the bracket cover comprises a first shaft fixing hole, a second shaft fixing hole and a third shaft fixing hole; and the bracket cover is screwed to the second shaft.

4. The curtain frame of claim 3, wherein the wire tray bracket comprises a wire tray base, at least two wire pulleys, a first fixed pulley, a second fixed pulley, a third fixed pulley, a fourth fixed pulley and a wire tray cover fixed to the wire tray base; the first fixed pulley and the second fixed pulley are movably clamped on the first protrusion part; the third fixed pulley and the fourth fixed pulley are movably clamped on the second protrusion part; the wire tray base includes two wire pulley shafts and four fixed pulley shafts; and the wire tray cover includes connecting rope apertures.

5. The curtain frame of claim 4, wherein the lower rod is formed as a hollow pipe; The cross-section of the lower rod is elliptical; a separator parallel to a long axis of the elliptical cross-section is arranged in the lower rod; an axial through-hole is provided on a plane of the lower rod; and a lower end of the curtain cloth is disposed between the separator and the axial through-hole.

6. The curtain frame of claim 5, further comprising a mounting bracket having an L-shaped mounting bracket body, a snap hook and a fixing stopper, the L-shaped mounting bracket body includes a first mounting body having a first mounting hole, and a second mounting body having a second mounting hole; a first L-folded part and a second L-folded part are arranged respectively on two sides of the second mounting body; the snap hook is clamped between the first L-folded part and the second L-folded part; and the fixing stopper is arranged in a recess arranged on a surface of the snap hook opposite to the second mounting body.
